(19) United States
(12) Patent Application Publication
(10) Pub. No.: US 2020/0122246 A1
(43) Pub. Date: Apr. 23, 2020

(54) COUNTERSINK GUIDE ASSEMBLIES AND RELATED METHODS

(71) Applicant: The Boeing Company, Chicago, IL (US)

(72) Inventors: Timothy D. Young, Saint Charles, MO (US); Adam S. Finck, Saint Louis, MO (US)

(21) Appl. No.: 16/165,330

(22) Filed: Oct. 19, 2018

(51) Int. Cl. B23B 51/10

(52) U.S. Cl. CPC B23B 51/104; B23B 2251/60

(57) ABSTRACT

Countersink guide assemblies and related methods. A countersink guide assembly includes a microstop cage and a stabilization guide. The microstop cage includes a cage sleeve, a cutter shaft, and a cutter that translates with respect to the cage sleeve as the cutter bores a countersink into a workpiece. The stabilization guide includes a guide body that defines a guide bore that receives the cage sleeve and a plurality of guide legs extending from the guide body. A method of boring a countersink into a workpiece includes positioning a microstop cage within a stabilization guide, engaging a workpiece with each of a plurality of guide legs, contacting the workpiece with a cage base, driving a cutter about a cage axis with a rotary driver, and transitioning the microstop cage to an extended configuration to bore the countersink into the workpiece with the cutter.

### FIELD

The present disclosure relates to countersink guide assemblies and related methods.

### BACKGROUND

When installing a fastener into a workpiece, it may be desirable to first bore a countersink into the workpiece such that a head of the fastener is flush with a remainder of the workpiece. In such applications, a microstop cage may be utilized to facilitate boring the countersink to a precise depth corresponding to a depth of the head of the fastener. However, in some applications, such as when boring a countersink into a curved surface, it may be difficult to maintain the microstop cage in static contact with the workpiece and/or in a perpendicular orientation with respect to the workpiece, potentially resulting in a non-conforming or discrepant countersink and requiring costly repairs.

### SUMMARY

Countersink guide assemblies and related methods are disclosed herein. A countersink guide assembly includes a microstop cage and a stabilization guide. The microstop cage includes a cage sleeve, a cutter shaft that extends within the cage sleeve, and a cutter that is supported on the cutter shaft and that is configured to bore a countersink into a workpiece. The cutter shaft extends along a cage axis and is configured to be operatively coupled to a rotary driver to rotate the cutter about the cage axis to bore the countersink. The cage sleeve includes a cage base such that at least a portion of the cage base is configured to contact the workpiece as the cutter bores the countersink into the workpiece. The microstop cage is configured to be selectively transitioned between a retracted configuration, in which the cutter is at least substantially received within the cage sleeve, and an extended configuration, in which a cutter tip of the cutter extends from the cage sleeve such that a distance between the cage base and the cutter tip, as measured along a direction parallel to the cage axis, is equal to a predetermined countersink depth. The cutter translates with respect to the cage sleeve in a first direction when the microstop cage transitions from the retracted configuration to the extended configuration and translates with respect to the cage sleeve in a second direction that is opposite the first direction when the microstop cage transitions from the extended configuration to the retracted configuration. The stabilization guide includes a guide body that defines a guide bore that extends along a guide axis and a plurality of guide legs extending from the guide body. The cage sleeve is received within the guide bore and is free to translate with respect to the guide bore along a direction at least substantially parallel to the guide axis. The guide bore is configured to maintain the cage axis in an orientation that is at least substantially parallel to the guide axis. Each guide leg of the plurality of guide legs is configured to contact the workpiece to stabilize the microstop cage relative to the workpiece as the cutter bores the countersink into the workpiece.

A method of boring a countersink into a workpiece includes positioning a microstop cage within a stabilization guide such that a cage sleeve of the microstop cage is received within a guide bore of the stabilization guide. The method further includes engaging a workpiece with each of a plurality of guide legs, contacting the workpiece with a cage base of the microstop cage, driving a cutter of the microstop cage to rotate about a cage axis with a rotary driver, and transitioning the microstop cage to an extended configuration to bore the countersink into the workpiece with the cutter.

### BRIEF DESCRIPTION OF THE DRAWINGS

FIG. 1 is a schematic cross-sectional side view illustrating examples of countersink guide assemblies according to the present disclosure.

FIG. 2 is a schematic top view illustrating examples of countersink guide assemblies according to the present disclosure.

FIG. 3 is a side perspective view illustrating an example of a microstop cage according to the present disclosure.

FIG. 4 is a perspective view illustrating a portion of an example of a stabilization guide according to the present disclosure.

FIG. 5 is a top view of the portion of the stabilization guide of FIG. 4.

FIG. 6 is a perspective view illustrating an example of a countersink guide assembly according to the present disclosure that includes the stabilization guide of FIGS. 4-5.

FIG. 7 is a perspective view illustrating the countersink guide assembly of FIG. 6 positioned relative to a workpiece and operatively coupled to a rotary driver, according to the present disclosure.

FIG. 8 is a perspective view illustrating a portion of another example of a stabilization guide according to the present disclosure.

FIG. 9 is a top view of the portion of the stabilization guide of FIG. 8.

FIG. 10 is a perspective view illustrating an example of a countersink guide assembly according to the present disclosure that includes the stabilization guide of FIGS. 9-10.

FIG. 11 is a flowchart schematically representing methods of boring a countersink into a workpiece according to the present disclosure.

FIG. 12 is a flow diagram of aircraft production and service methodology.

FIG. 13 is a block diagram of an aircraft.

### DESCRIPTION

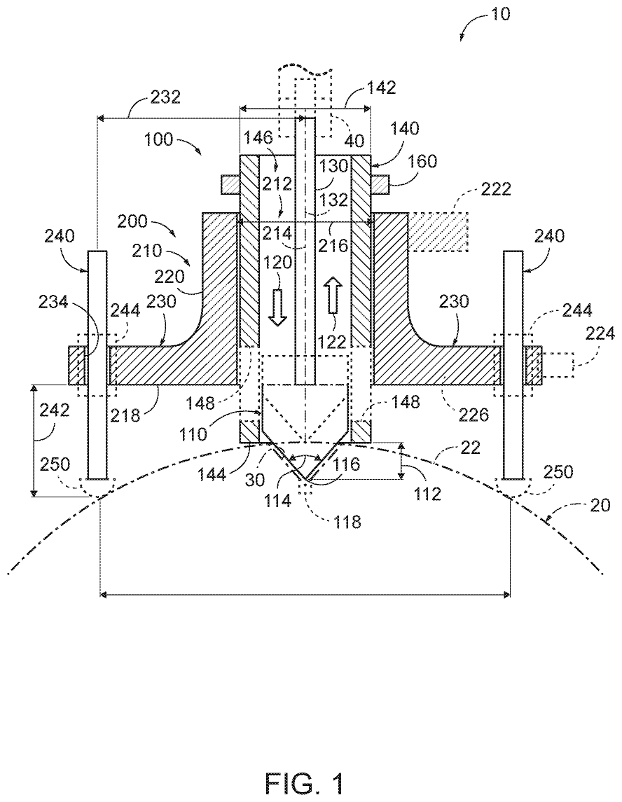

FIGS. 1-13 provide illustrative, non-exclusive examples of countersink guide assemblies 10 for boring a countersink 30 into a workpiece 20 and/or of methods 300 of boring a countersink into a workpiece, according to the present disclosure. Elements that serve a similar, or at least substantially similar, purpose are labeled with like numbers in each of FIGS. 1-13, and these elements may not be discussed in detail herein with reference to each of FIGS. 1-13. Similarly, all elements may not be labeled in each of FIGS. 1-13, but reference numerals associated therewith may be utilized herein for consistency. Elements, components, and/or features that are discussed herein with reference to one or more of FIGS. 1-13 may be included in and/or utilized with any of FIGS. 1-13 without departing from the scope of the present disclosure. Generally, in the figures, elements that are likely to be included in a given example are illustrated in solid lines, while elements that are optional to a given example are illustrated in dashed lines. However, elements that are illustrated in solid lines are not essential to all examples of the present disclosure, and an element shown in solid lines may be omitted from a particular example without departing from the scope of the present disclosure.

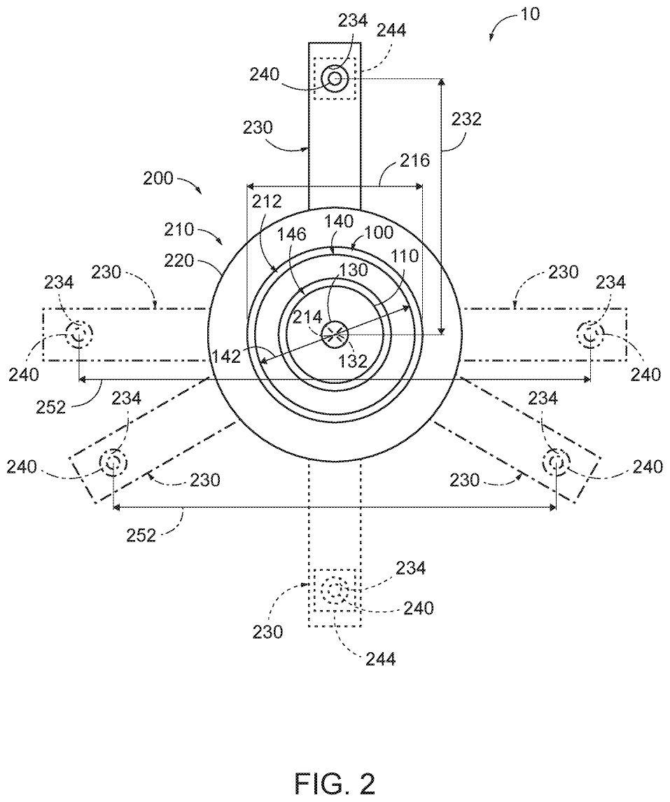

As schematically illustrated in FIGS. 1-2, a countersink guide assembly 10 includes a microstop cage 100 and a stabilization guide 200. Microstop cage 100 includes a cage sleeve 140, a cutter shaft 130 that extends within cage sleeve 140, and a cutter 110 that is supported on cutter shaft 130. As schematically illustrated in FIG. 1, cutter 110 is configured to bore a countersink 30 into a workpiece 20. More specifically, and as schematically illustrated in FIG. 1, cutter shaft 130 extends along a cage axis 132 and is configured to be operatively coupled to a rotary driver 40 to rotate cutter 110 about cage axis 132 to bore countersink 30. As further schematically illustrated in FIG. 1, cage sleeve 140 includes a cage base 144 such that at least a portion of cage base 144 contacts workpiece 20 as cutter 110 bores countersink 30 into workpiece 20.

Microstop cage 100 is configured to be selectively transitioned between a retracted configuration (schematically illustrated in dashed lines in FIG. 1), in which cutter 110 is at least substantially received within cage sleeve 140, and an extended configuration (schematically illustrated in solid lines in FIG. 1), in which a cutter tip 116 of cutter 110 extends from cage sleeve 140. Specifically, and as schematically illustrated in FIG. 1, when microstop cage 100 is in the extended configuration, a distance between cage base 144 and cutter tip 116, as measured along a direction parallel to cage axis 132, is equal to a predetermined countersink depth 112. As schematically illustrated in FIG. 1, cutter 110 translates with respect to cage sleeve 140 in a first direction 120 when microstop cage 100 transitions from the retracted configuration to the extended configuration, and translates with respect to cage sleeve 140 in a second direction 122, which is opposite first direction 120, when microstop cage 100 transitions from the extended configuration to the retracted configuration. Microstop cage 100 generally is configured to restrict cutter 110 from translating in first direction 120 beyond the extended configuration. In this manner, microstop cage 100 facilitates limiting a depth of countersink 30 to the predetermined countersink depth 112. Microstop cage 100 may be biased toward the retracted configuration, such as to prevent inadvertent extension of cutter 110 from cutter shaft 130.

Microstop cage 100 generally is configured to bore countersink 30 to a precise depth within workpiece 20. For example, workpiece 20 may include and/or be a surface, such as an aerodynamic surface of an aircraft, in which it is desirable to receive a fastener such that a head of the fastener is at least substantially flush, coextensive, and/or coplanar with a surrounding region of workpiece 20. In such an example, utilizing microstop cage 100 to form countersink 30 within workpiece 20 may facilitate precisely and repeatedly forming countersink 30 with a depth equal to countersink depth 112, such as may correspond to a depth of the head of a fastener installed within countersink 30.

In an example in which workpiece 20 is substantially flat and/or planar, microstop cage 100 also may be configured to facilitate boring countersink 30 while maintaining cage axis 132 at least substantially perpendicular to workpiece 20. For example, cage base 144 may extend at least substantially, and optionally fully, around cage axis 132 such that cage base 144 contacts workpiece 20 along substantially the full perimeter of cage base 144 as cutter 110 bores countersink 30 into workpiece 20. In such an example, maintaining cage base 144 and workpiece 20 in static contact with one another along the full perimeter of cage base 144 may serve to maintain microstop cage 100 in a perpendicular orientation with respect to workpiece 20. However, in an application in which workpiece 20 is non-planar, uneven, curved, and/or contoured, engagement between cage base 144 and workpiece 20 may not be sufficient to maintain cage axis 132 substantially perpendicular to workpiece 20. As an example, and as schematically illustrated in FIG. 1, workpiece 20 may be substantially cylindrical, such that cage base 144 contacts a curved surface 22 of workpiece 20 at two opposed points (not visible in the cross-sectional view of FIG. 1) and such that a remainder of cage base 144 is spaced apart from workpiece 20. In such an example, microstop cage 100 may be prone to tilting with respect to workpiece 20 while cutter 110 bores countersink 30, which may result in countersink 30 being formed with elongated and/or imprecise dimensions, potentially necessitating costly repairs. Accordingly, countersink guide assemblies 10 according to the present disclosure include stabilization guide 200 for stabilizing microstop cage 100 with respect to workpiece 20.

With continued reference to FIGS. 1-2, stabilization guide 200 includes a guide body 210 that defines a guide bore 212 that extends along a guide axis 214, and additionally includes a plurality of guide legs 240 extending from guide body 210. During operative use of countersink guide assembly 10, cage sleeve 140 of microstop cage 100 is received within guide bore 212 of stabilization guide 200 such that cage sleeve 140 is free to translate and/or slide with respect to guide bore 212 along a direction at least substantially parallel to guide axis 214. In this manner, stabilization guide 200 may support microstop cage 100 such that microstop cage 100 may bore countersink 30 into workpiece 20 to a given countersink depth 112 regardless of whether a surface of workpiece 20 is flat (e.g., planar) or curved. That is, and as described herein, because cage sleeve 140 is free to translate with respect to guide bore 212, cage base 144 contacts workpiece 20 at an orientation defined (and constrained) by the configuration of the plurality of guide legs 240. Thus, the depth of countersink 30 bored into workpiece 20, as measured from a point at which cage base 144 contacts workpiece 20, is constant (i.e., substantially equal to countersink depth 112) regardless of whether workpiece 20 is flat (e.g., planar) or curved.

Guide bore 212 generally is configured to maintain cage axis 132 in an orientation that is at least substantially parallel to guide axis 214. In this manner, maintaining guide axis 214 of stabilization guide 200 at least substantially perpendicular to workpiece 20 may in turn serve to maintain cage axis 132 of microstop cage 100 in an orientation that is at least substantially perpendicular to workpiece 20 as well. To this end, each guide leg 240 is configured to contact workpiece 20 to stabilize stabilization guide 200, and hence microstop cage 100, relative to workpiece 20 as cutter 110 bores countersink 30 into workpiece 20. In this manner, stabilization guide 200 also may be described as being configured to maintain cage base 144 in static contact with workpiece 20 as cutter 110 bores countersink 30 into workpiece 20.

While the examples disclosed and illustrated herein generally relate to applications in which it is desirable to maintain cage axis 132 perpendicular to workpiece 20 as cutter 110 bores countersink 30 into workpiece 20, this is not required to all examples of countersink guide assembly 10, and it is additionally within the scope of the present disclosure that stabilization guide 200 may be utilized to maintain cage axis 132 at any appropriate orientation relative to workpiece 20 as cutter 110 bores countersink 30 into workpiece 20.

Stabilization guide 200 and/or guide bore 212 may be configured to maintain cage axis 132 in an orientation that is at least substantially parallel to guide axis 214 in any appropriate manner. For example, stabilization guide 200 may be configured such that guide bore 212 receives cage sleeve 140 in a close-fit or slide-fit engagement. For example, and as schematically illustrated in FIGS. 1-2, cage sleeve 140 may be characterized by a cage sleeve outer diameter 142, as measured along a direction perpendicular to cage axis 132, and guide bore 212 may be characterized by a guide bore inner diameter 216, as measured along a direction perpendicular to guide axis 214, such that guide bore inner diameter 216 is larger than cage sleeve outer diameter 142. As more specific examples, guide bore inner diameter 216 may be at least 1% larger than cage sleeve outer diameter 142, at least 2% larger than cage sleeve outer diameter 142, at least 5% larger than cage sleeve outer diameter 142, at most 10% larger than cage sleeve outer diameter 142, at most 7% larger than cage sleeve outer diameter 142, and/or at most 3% larger than cage sleeve outer diameter 142. Additionally or alternatively, guide bore inner diameter 216 may be at least 0.05 millimeters (mm) larger than cage sleeve outer diameter 142, at least 0.1 mm larger than cage sleeve outer diameter 142, at least 0.5 mm larger than cage sleeve outer diameter 142, at least 1 mm larger than cage sleeve outer diameter 142, at most 2 mm larger than cage sleeve outer diameter 142, at most 0.7 mm larger than cage sleeve outer diameter 142, at most 0.2 mm larger than cage sleeve outer diameter 142, and/or at most 0.07 mm larger than cage sleeve outer diameter 142. Guide bore 212 may receive and/or engage cage sleeve 140 in any appropriate manner when cage sleeve 140 is operatively received within guide bore 212. For example, cage sleeve 140 may be free to rotate with respect to guide bore 212 about guide axis 214. Alternatively, cage sleeve 140 may be restricted from rotating with respect to guide bore 212 about guide axis 214.

With continued reference to FIGS. 1-2, stabilization guide 200 may include any appropriate number of guide legs 240. As examples, stabilization guide 200 may include two guide legs 240 (schematically illustrated in solid and dashed lines in FIG. 2), three guide legs 240 (schematically illustrated in solid and dash-dot lines in FIG. 2), four guide legs 240 (schematically illustrated in solid, dash-dot, and dash-dot-dot lines in FIG. 2), or more than four guide legs 240.

Each guide leg 240 may extend from guide body 210 in any appropriate manner. For example, and as schematically illustrated in FIGS. 1-2, guide body 210 may define a plurality of leg receivers 234 extending through guide body 210 such that each guide leg 240 extends through a respective leg receiver 234 to operatively couple the guide leg 240 to guide body 210. As another example, and as schematically illustrated in FIG. 1, guide body 210 may be described as including a guide base 218 that faces workpiece 20 during operative use of countersink guide assembly 10, and each guide leg 240 may extend from guide base 218 by a respective leg offset 242, as measured along a direction parallel to guide axis 214. Each guide leg 240 of the plurality of guide legs 240 may have the same leg offset 242. Alternatively, one or more guide legs 240 may have a respective leg offset 242 that is different than the respective leg offset 242 of one or more other guide legs 240.

Stabilization guide 200 also may be configured such that one or more guide legs 240 have a respective leg offset 242 that is adjustable. For example, and as schematically illustrated in FIGS. 1-2, stabilization guide 200 may include one or more leg adjustment mechanisms 244, each configured to adjust leg offset 242 of a respective guide leg 240. Leg adjustment mechanism 244 may include and/or be any appropriate mechanism, such as a threaded adjustment mechanism, a ratcheting adjustment mechanism, and/or a cam-lock adjustment mechanism. In some examples, guide leg 240 may include at least a portion of and/or at least partially define leg adjustment mechanism 244. For example, leg adjustment mechanism 244 may be a threaded adjustment mechanism, and guide leg 240 may include threads and/or a fastener head for threading into the respective leg receiver 234.

Each guide leg 240 may be configured to contact workpiece 20 in any appropriate manner. For example, and as schematically illustrated in FIG. 1, one or more guide legs 240 may include a respective guide foot 250 configured to contact workpiece 20. Guide foot 250 may be configured to remain in static contact with workpiece 20 as cutter 110 bores countersink 30 into workpiece 20, such as to augment the stability of microstop cage 100 relative to workpiece 20. For example, guide foot 250 may be formed of a material such that a coefficient of static friction between guide foot 250 and workpiece 20 is greater than a coefficient of static friction between a remainder of the respective guide leg 240 and workpiece 20. As a more specific example, guide foot 250 may be formed of a rubber.

Each guide leg 240 may be configured to contact workpiece 20 at a location distal cutter tip 116 relative to cage base 144, such as to augment a stability of stabilization guide 200 and/or microstop cage 100 upon workpiece 20. Stated differently, the stability of stabilization guide 200 upon workpiece 20 may be enhanced by virtue of guide legs 240 contacting workpiece 20 at widely spaced-apart points relative to a width of cage sleeve 140. More specifically, and as schematically illustrated in FIGS. 1-2, the plurality of guide legs 240 collectively may define a guide footprint 252, as measured between the respective guide feet 250 of two guide legs 240 that are maximally spaced apart and as measured along a direction perpendicular to guide axis 124 when each guide leg 240 contacts workpiece 20. As examples, guide footprint 252 may be at least 125% of guide bore inner diameter 216, at least 175% of guide bore inner diameter 216, at least 200% of guide bore inner diameter 216, at least 300% of guide bore inner diameter 216, at most 400% of guide bore inner diameter 216, at most 250% of guide bore inner diameter 216, and/or at most 150% of guide bore inner diameter 216.

As further schematically illustrated in FIGS. 1-2, guide body 210 additionally may include a central body portion 220 that defines guide bore 212 and a plurality of guide arms 230 extending from central body portion 220. More specifically, guide arms 230, when present, extend generally away from guide axis 214, such as along a direction that is at least substantially perpendicular to guide axis 214. However, this is not required to all examples of guide body 210, and it is additionally within the scope of the present disclosure that guide arms 230 may extend generally away from guide axis 214 along any appropriate direction, such as a direction that is angled and/or oblique with respect to guide axis 214. In an example of guide body 210 that includes the plurality of guide arms 230, each guide leg 240 may extend from a respective guide arm 230. Stated differently, each guide arm 230 may include and/or define a respective leg receiver 234.

Stabilization guide 200 may include any appropriate number of guide arms 230, such as may correspond to the number of guide legs 240. As examples, and as schematically illustrated in FIG. 2, stabilization guide 200 may include two guide arms 230 (schematically illustrated in solid and dashed lines in FIG. 2), three guide arms 230 (schematically illustrated in solid and dash-dot lines in FIG. 2), four guide arms 230 (schematically illustrated in solid, dash-dot, and dash-dot-dot lines in FIG. 2), or more than four guide arms 230.

The plurality of guide arms 230 collectively may serve to enhance a stability of stabilization guide 200, such as by increasing guide footprint 252 relative to an otherwise identical stabilization guide 200 that lacks the guide arms 230. For example, and as schematically illustrated in FIGS. 1-2, each guide arm 230 may be characterized by an arm length 232, as measured between guide axis 214 and the guide leg 240 that extends from guide arm 230 and along a direction perpendicular to guide axis 214. As more specific examples, arm length 232 may be at least 60% of guide bore inner diameter 216, at least 75% of guide bore inner diameter 216, at least 100% of guide bore inner diameter 216, at least 125% of guide bore inner diameter 216, at least 150% of guide bore inner diameter 216, at most 200% of guide bore inner diameter 216, at most 130% of guide bore inner diameter 216, at most 110% of guide bore inner diameter 216, at most 90% of guide bore inner diameter 216, and/or at most 70% of guide bore inner diameter 216.

While the examples disclosed and illustrated herein generally relate to embodiments in which stabilization guide 200 includes a plurality of guide arms 230, this is not required to all examples of stabilization guide 200, and it is additionally within the scope of the present disclosure that stabilization guide 200 may not include distinct guide arms 230. As an example, guide body 210 may extend away from guide axis 214 as a single (e.g., undifferentiated) flange. In such an example, guide body 210 may include the plurality of leg receivers 234, such as at respective locations that are distal guide axis 214. In such examples, a position of each leg receiver 234 and/or guide leg 240 relative to guide axis 214 may be characterized by arm length 232 as defined and discussed above.

Microstop cage 100 and/or cutter 110 may be configured to bore countersink 30 into workpiece 20 in any appropriate manner. For example, and as discussed, cutter 110 generally is configured to be rotated (e.g., spun at high speed) about cage axis 132 by rotary driver 40. Rotary driver 40 may include and/or be any appropriate tool and/or apparatus for driving cutter 110. As examples, rotary driver 40 may include and/or be a drill, a drill press, a milling machine, a hand-held tool, a power tool, an electrically powered tool, and/or a pneumatically powered tool. In some examples, countersink guide assembly 10 further may be described as including rotary driver 40.

As discussed, cutter 110 generally is configured to bore a countersink 30 into workpiece 20, such as a conical countersink 30. Accordingly, cutter 110 may be at least substantially conical. In such examples, and as schematically illustrated in FIG. 1, cutter 110 and/or countersink 30 may define an included angle 114, as measured in a plane that is parallel to and/or includes cage axis 132, that is at least 45 degrees, at least 60 degrees, at least 75 degrees, at least 90 degrees, at least 105 degrees, at least 120 degrees, at least 135 degrees, at most 150 degrees, at most 140 degrees, at most 125 degrees, at most 110 degrees, at most 95 degrees, at most 80 degrees, and/or at most 65 degrees. As further schematically illustrated in FIG. 1, cutter 110 additionally may include a pilot 118 extending from cutter tip 116. When present, pilot 118 may be configured to be received within a predrilled pilot hole to align cutter 110 relative to workpiece 20, and/or may be configured to bore a pilot hole into workpiece 20 prior to cutter 110 boring countersink 30 into workpiece 20.

As discussed, microstop cage 100 generally is configured to facilitate boring countersink 30 to a precise countersink depth 112. Countersink depth 112 may be any appropriate depth, such as may correspond to a depth of a fastener head that is received within countersink 30. As examples, countersink depth 112 may be at least 1 mm, at least 3 mm, at least 5 mm, at least 10 mm, at least 15 mm, at least 30 mm, at most 50 mm, at most 20 mm, at most 17 mm, at most 12 mm, at most 7 mm, and/or at most 2 mm. Microstop cage 100 may be configured to bore countersink 30 to a single predetermined countersink depth 112, or may be configured to bore countersink 30 to one of a plurality and/or continuum of predetermined countersink depths 112. For example, and as schematically illustrated in FIG. 1, microstop cage 100 may include a depth adjustment mechanism 160 for selectively adjusting countersink depth 112. Depth adjustment mechanism 160 may include and/or be any appropriate mechanism, such as a twist dial and/or a threaded adjustment mechanism.

Cage sleeve 140 of microstop cage 100 may have any appropriate configuration. For example, and as discussed, cage base 144 of cage sleeve 140 may extend substantially and/or fully around cage axis 132, such as to permit cage base 144 to contact workpiece 20 along a full perimeter of cage base 144. However, this is not required to all examples and/or applications of countersink guide assembly 10, and it is additionally within the scope of the present disclosure that cage base 144 may not extend fully around cage axis 132 and/or that cage base 144 may contact workpiece 20 at each of two or more spaced-apart points. Additionally or alternatively, and as schematically illustrated in FIG. 1, cage sleeve 140 may define one or more cage windows 148 configured to permit visual inspection of cutter 110 within cage sleeve 140 while cutter 110 is at least partially received within cage sleeve 140.

With continued reference to FIG. 1, stabilization guide 200 further may include any appropriate features for facilitating use of countersink guide assembly 10. For example, and as schematically illustrated in FIG. 1, stabilization guide 200 additionally may include a guide handle 222 extending from guide body 210 (such as away from guide axis 214) and configured to be gripped by a user during use of countersink guide assembly 10. Additionally or alternatively, stabilization guide 200 may include one or more components configured to interface with a vacuum source, such as to facilitate removal of fragments of workpiece 20 as countersink 30 is bored into workpiece 20. For example, and as further schematically illustrated in FIG. 1, stabilization guide 200 additionally may include a vacuum port 224 configured to be selectively coupled to a vacuum source and/or a vacuum conduit 226 configured to direct a vacuum at least partially through guide body 210.

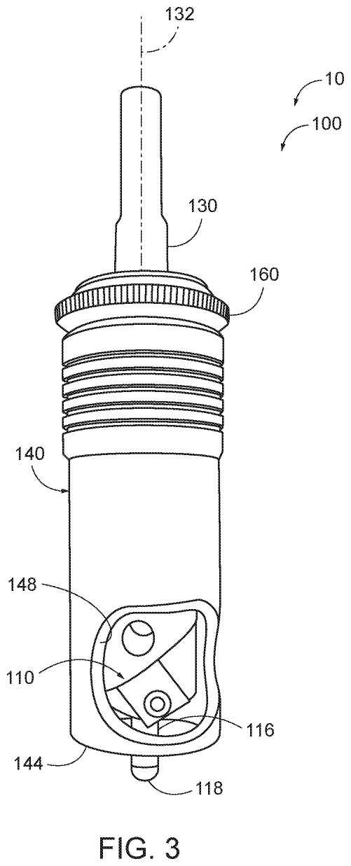

Turning now to FIGS. 3-10, FIG. 3 illustrates an example of microstop cage 100, such as may be utilized in countersink guide assembly 10. In the example of FIG. 3, microstop cage 100 includes cage sleeve 140 with cage base 144 that extends fully around cage axis 132 and with cage window 148. The example of microstop cage 100 of FIG. 3 additionally includes depth adjustment mechanism 160 and cutter 110 with pilot 118 extending from cutter tip 116.

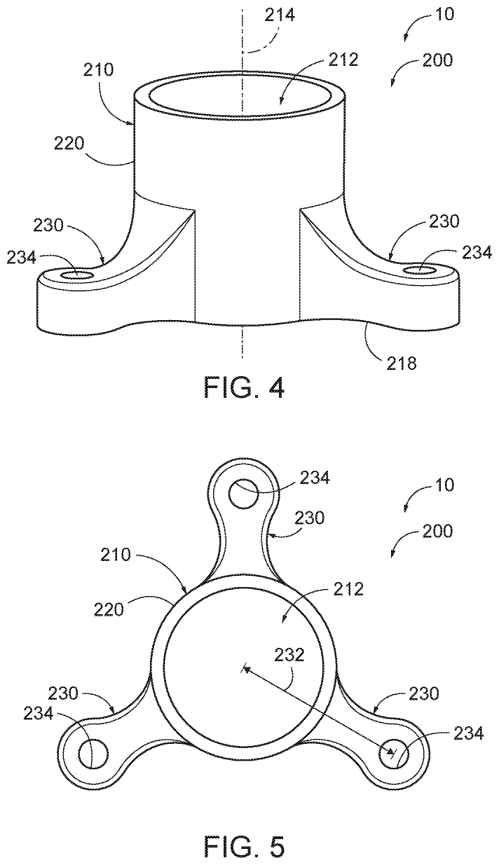

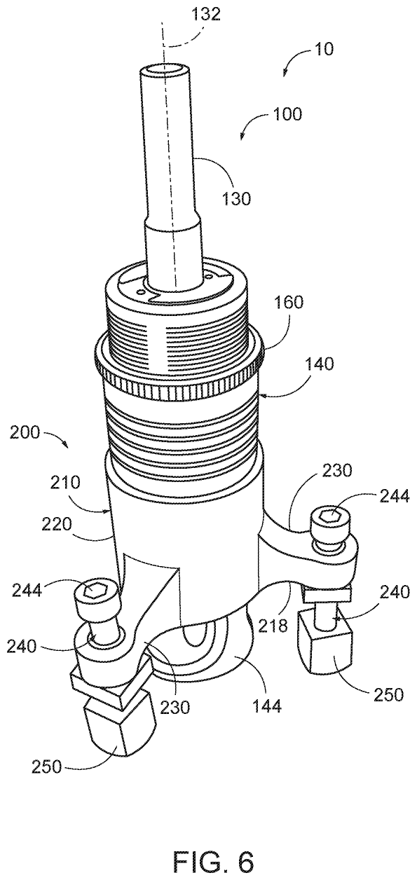

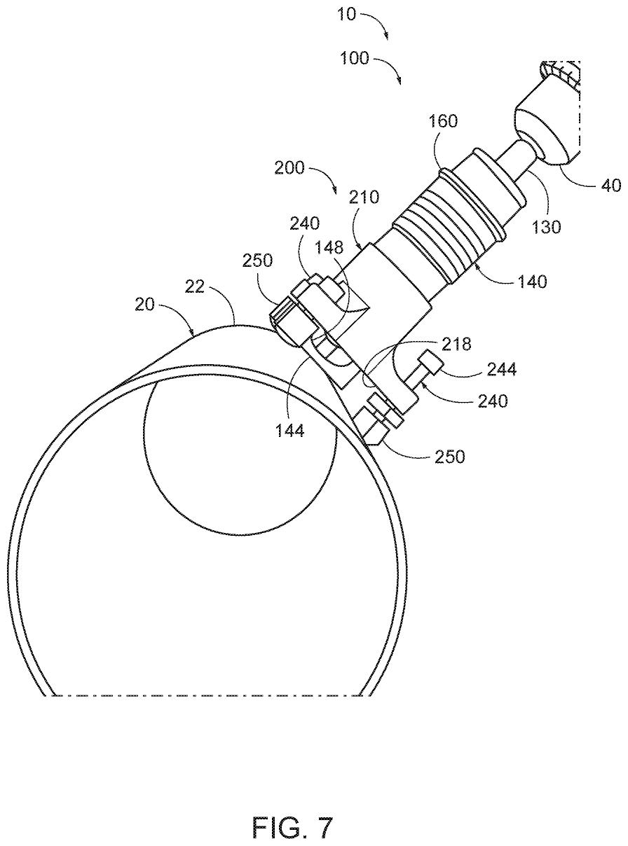

FIGS. 4-5 illustrate a portion of an example of stabilization guide 200, while FIGS. 6-7 illustrate an example of countersink guide assembly 10 that includes stabilization guide 200 of FIGS. 4-5. As illustrated, stabilization guide 200 of FIGS. 4-7 includes three guide arms 230, each of which defines a respective leg receiver 234 (labeled in FIGS. 4-5). As illustrated in FIGS. 6-7, each guide leg 240 includes a portion of leg adjustment mechanism 244 in the form of a threaded engagement between guide leg 240 and the respective leg receiver 234. Each guide leg 240 also may be described as including leg adjustment mechanism 244 in the form of a socket head shaped to receive a driver, such as a hexagonal key. As further illustrated in FIGS. 6-7, each guide leg 240 of countersink guide assembly 10 of FIGS. 6-7 includes a respective guide foot 250, such as a rubber guide foot 250. FIG. 7 illustrates countersink guide assembly 10 operatively positioned relative to workpiece 20 that includes curved surface 22.

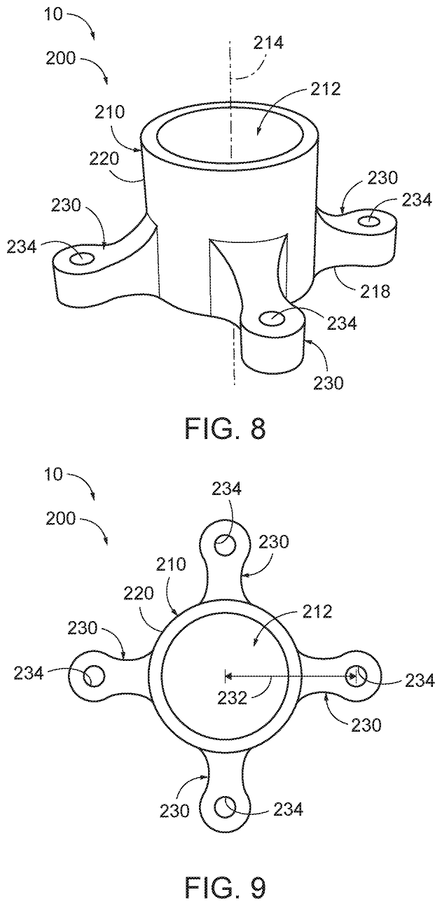

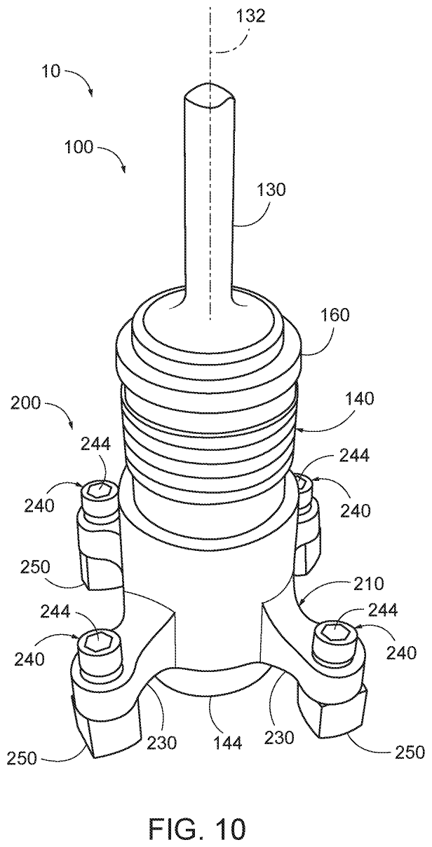

FIGS. 8-9 illustrate a portion of another example of stabilization guide 200, while FIG. 10 illustrates an example of countersink guide assembly 10 that includes stabilization guide 200 of FIGS. 8-9. As illustrated, stabilization guide 200 of FIGS. 8-10 includes four guide arms 230, each of which defines a respective leg receiver 234 (labeled in FIGS. 8-9). As illustrated in FIG. 10, each guide leg 240 includes a portion of leg adjustment mechanism 244 in the form of a threaded engagement between guide leg 240 and the respective leg receiver 234 (not visible in FIG. 10) as well as in the form of a socket head shaped to receive a driver, such as a hexagonal key. As further illustrated in FIG. 10, each guide leg 240 of countersink guide assembly 10 of FIG. 10 includes a respective guide foot 250, such as a rubber guide foot 250.

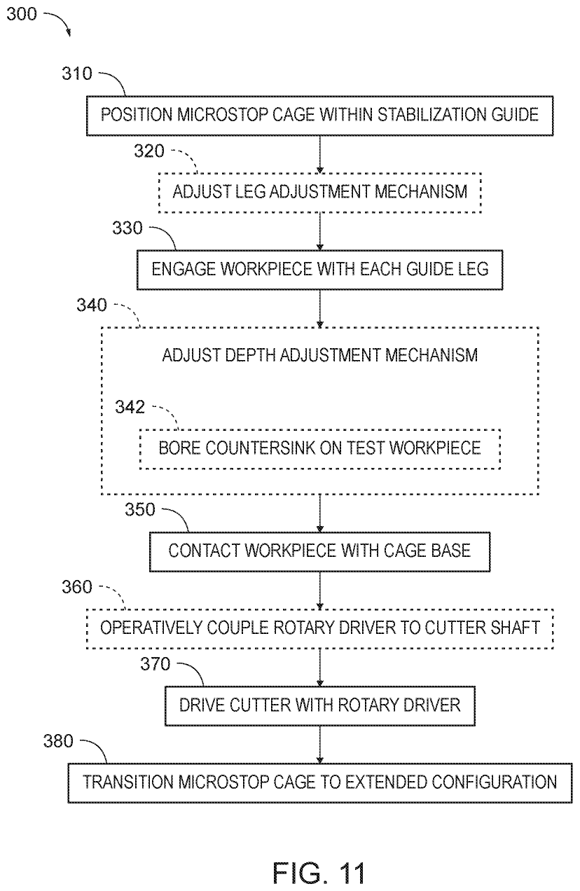

FIG. 11 is a flowchart depicting methods 300, according to the present disclosure, of boring a countersink (such as countersink 30) into a workpiece (such as workpiece 20). As shown in FIG. 11, a method 300 includes positioning, at 310, a microstop cage (such as microstop cage 100) of a countersink guide assembly (such as countersink guide assembly 10) within a stabilization guide (such as stabilization guide 200) of the countersink guide assembly. Specifically, the positioning at 310 includes positioning such that a cage sleeve of the microstop cage (such as cage sleeve 140 of microstop cage 100) is received within a guide bore of the stabilization guide (such as guide bore 212 of stabilization guide 200) and such that the cage sleeve is free to translate with respect to the guide bore along a direction at least substantially parallel to a guide axis (such as guide axis 214). Method 300 additionally includes engaging, at 330, the workpiece with each guide leg (such as each guide leg 240) of a plurality of guide legs and contacting, at 350, the workpiece with a cage base of the cage sleeve (such as cage base 144 of cage sleeve 140). Method 300 further includes driving, at 370, a cutter (such as cutter 110) to rotate about a cage axis (such as cage axis 132) with a rotary driver (such as rotary driver 40) and transitioning, at 380, the microstop cage to an extended configuration to bore the countersink into the workpiece with the cutter. As additionally shown in FIG. 11, method 300 additionally may include, prior to the driving at 370, operatively coupling, at 360, the rotary driver to a cutter shaft (such as cutter shaft 130).

As further shown in FIG. 11, method 300 additionally may include, prior to the transitioning at 380, adjusting, at 320, a leg offset (such as leg offset 242) of one or more guide legs with a leg adjustment mechanism (such as leg adjustment mechanism 244). The adjusting at 320 may be performed in any appropriate manner. For example, the adjusting at 320 may include adjusting such that the guide axis is at least substantially perpendicular to the workpiece, and may be performed either prior to the engaging at 330 or subsequent to the engaging at 330. The adjusting at 320 may include adjusting the leg offset of one guide leg of the plurality of guide legs, or may include adjusting the respective leg offsets of each of two or more guide legs.

As further shown in FIG. 11, method 300 further may include, prior to the transitioning at 380, adjusting, at 340, a depth adjustment mechanism of the microstop cage (such as depth adjustment mechanism 160 of microstop cage 100) to set a countersink depth (such as countersink depth 112). The adjusting at 340 may be performed at any appropriate stage in method 300. As examples, the adjusting at 240 may be performed prior to the positioning at 310, or may be performed subsequent to the positioning at 310. As additionally shown in FIG. 11, the adjusting at 340 additionally may include boring, at 342, a test countersink (such as an additional countersink 30) on a test workpiece (such as an additional workpiece 20) with the microstop cage to confirm the countersink depth. For example, and as discussed, countersink guide assemblies according to the present disclosure generally are configured such that the countersink depth, such as may be set by the depth adjustment mechanism, is constant regardless of whether the workpiece is flat (e.g., planar) or curved. As discussed, this property derives from the fact that the cage sleeve of the microstop cage is free to translate within the guide bore of the stabilization guide, such that the cage base of the cage sleeve contacts the workpiece at an orientation defined by the respective leg offsets of the guide legs regardless of a curvature of the workpiece. Accordingly, the boring at 342 may include boring the test countersink into a test workpiece that is at least substantially planar (such as a test coupon of relatively inexpensive construction relative to the workpiece) to set and/or confirm the countersink depth, and the workpiece into which the countersink is bored during the transitioning at 380 may be at least partially curved. In such an example, the depth of the countersink that is bored into the workpiece (as measured from a point at which the cage base contacts the workpiece) is equal to the depth of the test countersink that is bored into the test workpiece, thereby facilitating forming the countersink reliably and precisely in a workpiece that may be of relatively expensive construction (e.g., relative to the test coupon).

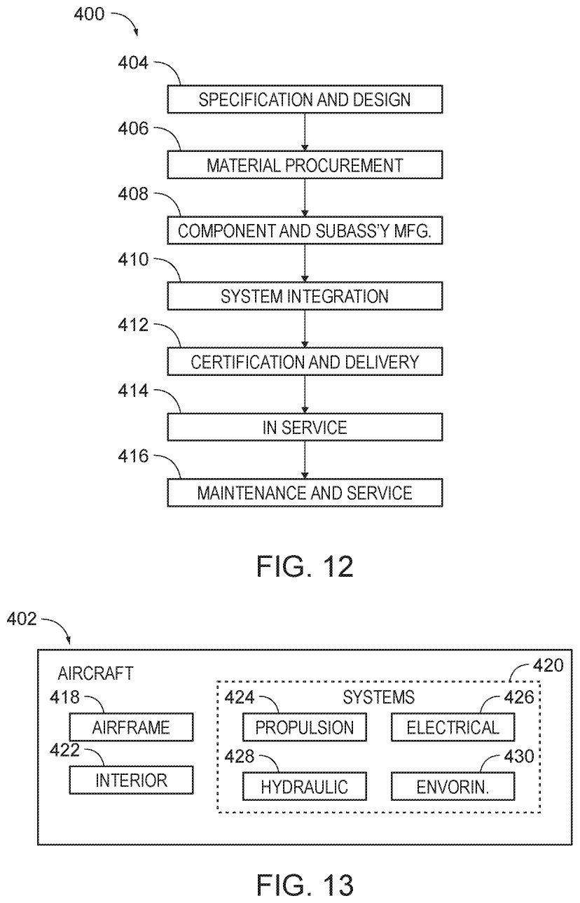

Referring now to FIGS. 12-13, embodiments of the disclosure may be described in the context of an aircraft manufacturing and service method 400 as shown in FIG. 12 and an aircraft 402 as shown in FIG. 13. During pre-production, exemplary method 400 may include specification and design 404 of the aircraft 402 and material procurement 406. During production, component and subassembly manufacturing 408 and system integration 410 of the aircraft 402 takes place. Thereafter, the aircraft 402 may go through certification and delivery 412 in order to be placed in service 414. While in service by a customer, the aircraft 402 is scheduled for routine maintenance and service 416 (which may also include modification, reconfiguration, refurbishment, and so on).

Each of the processes of method 400 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 13, the aircraft 402 produced by exemplary method 400 may include an airframe 418 with a plurality of systems 420 and an interior 422. Examples of high-level systems 420 include one or more of a propulsion system 424, an electrical system 426, a hydraulic system 428, and an environmental system 430. Any number of other systems may be included. Although an aerospace example is shown, the principles of the invention may be applied to other industries, such as the automotive industry.

Apparatus and methods embodied herein may be employed during any one or more of the stages of the production and service method 400. For example, components or subassemblies corresponding to production process 408 may be fabricated or manufactured in a manner similar to components or subassemblies produced while the aircraft 402 is in service. Also, one or more apparatus embodiments, method embodiments, or a combination thereof may be utilized during the production stages 408 and 410, for example, by substantially expediting assembly of or reducing the cost of an aircraft 402. Similarly, one or more of apparatus embodiments, method embodiments, or a combination thereof may be utilized while the aircraft 402 is in service, for example and without limitation, to maintenance and service 416.

Illustrative, non-exclusive examples of inventive subject matter according to the present disclosure are described in the following enumerated paragraphs:

A1. A countersink guide assembly for boring a countersink into a workpiece, comprising:

a microstop cage; and

a stabilization guide;

wherein the microstop cage includes:
a cage sleeve;
a cutter shaft that extends within the cage sleeve; and
a cutter that is supported on the cutter shaft and that is configured to bore the countersink into the workpiece;

wherein the cutter shaft extends along a cage axis; wherein the cutter shaft is configured to be operatively coupled to a rotary driver to rotate the cutter about the cage axis to bore the countersink; wherein the cage sleeve includes a cage base; wherein at least a portion of the cage base is configured to contact the workpiece as the cutter bores the countersink into the workpiece; wherein the microstop cage is configured to be selectively transitioned between a retracted configuration, in which the cutter is at least substantially received within the cage sleeve, and an extended configuration, in which a cutter tip of the cutter extends from the cage sleeve such that a distance between the cage base and the cutter tip, as measured along a direction parallel to the cage axis, is equal to a predetermined countersink depth; wherein the cutter translates with respect to the cage sleeve in a first direction when the microstop cage transitions from the retracted configuration to the extended configuration; wherein the cutter translates with respect to the cage sleeve in a second direction that is opposite the first direction when the microstop cage transitions from the extended configuration to the retracted configuration;

wherein the stabilization guide includes:
a guide body that defines a guide bore that extends along a guide axis; and
a plurality of guide legs extending from the guide body;

wherein the cage sleeve is received within the guide bore; wherein the cage sleeve is free to translate with respect to the guide bore along a direction at least substantially parallel to the guide axis; wherein the guide bore is configured to maintain the cage axis in an orientation that is at least substantially parallel to the guide axis; and wherein each guide leg of the plurality of guide legs is configured to contact the workpiece to stabilize the microstop cage relative to the workpiece as the cutter bores the countersink into the workpiece.

A2. The countersink guide assembly of paragraph A1, wherein the microstop cage is configured to restrict the cutter from translating in the first direction beyond the extended configuration.

A3. The countersink guide assembly of any of paragraphs A1-A2, wherein the stabilization guide is configured to maintain the cage axis in an orientation that is at least substantially perpendicular to the workpiece as the cutter bores the countersink into the workpiece.

A4. The countersink guide assembly of any of paragraphs A1-A3, wherein the stabilization guide is configured to maintain the cage base in static contact with the workpiece as the cutter bores the countersink into the workpiece.

A5. The countersink guide assembly of any of paragraphs A1-A4, wherein the workpiece has a surface that is one or more of non-planar, uneven, curved, and contoured.

A6. The countersink guide assembly of any of paragraphs A1-A5, further comprising the rotary driver operatively coupled to the cutter shaft.

A7. The countersink guide assembly of any of paragraphs A1-A6, wherein the rotary driver includes one or more of a drill, a drill press, a milling machine, a hand-held tool, a power tool, an electrically powered tool, and a pneumatically powered tool.

A8. The countersink guide assembly of any of paragraphs A1-A7, wherein the cutter is at least substantially conical.

A9. The countersink guide assembly of any of paragraphs A1-A8, wherein the cutter defines an included angle that is one or more of at least 45 degrees, at least 60 degrees, at least 75 degrees, at least 90 degrees, at least 105 degrees, at least 120 degrees, at least 135 degrees, at most 150 degrees, at most 140 degrees, at most 125 degrees, at most 110 degrees, at most 95 degrees, at most 80 degrees, and at most 65 degrees.

A10. The countersink guide assembly of any of paragraphs A1-A9, wherein the cutter includes a pilot that extends from the cutter tip.

A11. The countersink guide assembly of any of paragraphs A1-A10, wherein the microstop cage is biased toward the retracted configuration.

A12. The countersink guide assembly of any of paragraphs A1-A11, wherein the cage base extends at least substantially, and optionally fully, around the cage axis.

A13. The countersink guide assembly of any of paragraphs A1-A12, wherein the cage base is configured to contact the workpiece at each of two or more spaced-apart points as the cutter bores the countersink into the workpiece.

A14. The countersink guide assembly of any of paragraphs A1-A13, wherein the cage base is configured to contact the workpiece along a full perimeter of the cage base as the cutter bores the countersink into the workpiece.

A15. The countersink guide assembly of any of paragraphs A1-A14, wherein the countersink depth is one or more of at least 1 millimeter (mm), at least 3 mm, at least 5 mm, at least 10 mm, at least 15 mm, at least 30 mm, at most 50 mm, at most 20 mm, at most 17 mm, at most 12 mm, at most 7 mm, and at most 2 mm.

A16. The countersink guide assembly of any of paragraphs A1-A15, wherein the microstop cage includes a depth adjustment mechanism for selectively adjusting the countersink depth.

A17. The countersink guide assembly of any of paragraphs A1-A16, wherein the cage sleeve defines one or more cage windows configured to permit visual inspection of the cutter within the cage sleeve while the cutter is at least partially received within the cage sleeve.

A18. The countersink guide assembly of any of paragraphs A1-A17, wherein the cage sleeve has a cage sleeve outer diameter, as measured along a direction perpendicular to the cage axis; wherein the guide bore has a guide bore inner diameter, as measured along a direction perpendicular to the guide axis; and wherein the guide bore inner diameter is larger than the cage sleeve outer diameter.

A19. The countersink guide assembly of paragraph A18, wherein the guide bore inner diameter is one or more of at least 1% larger than the cage sleeve inner diameter, at least 2% larger than the cage sleeve inner diameter, at least 5% larger than the cage sleeve inner diameter, at most 10% larger than the cage sleeve inner diameter, at most 7% larger than the cage sleeve inner diameter, and at most 3% larger than the cage sleeve inner diameter.

A20. The countersink guide assembly of any of paragraphs A18-A19, wherein the guide bore inner diameter is one or more of at least 0.05 mm larger than the cage sleeve outer diameter, at least 0.1 mm larger than the cage sleeve outer diameter, at least 0.5 mm larger than the cage sleeve outer diameter, at least 1 mm larger than the cage sleeve outer diameter, at most 2 mm larger than the cage sleeve outer diameter, at most 0.7 mm larger than the cage sleeve outer diameter, at most 0.2 mm larger than the cage sleeve outer diameter, and/or at most 0.07 mm larger than the cage sleeve outer diameter.

A21. The countersink guide assembly of any of paragraphs A1-A20, wherein the cage sleeve is free to rotate with respect to the guide bore about the guide axis.

A22. The countersink guide assembly of any of paragraphs A1-A20, wherein the cage sleeve is restricted from rotating with respect to the guide bore about the guide axis.

A23. The countersink guide assembly of any of paragraphs A1-A22, wherein the plurality of guide legs includes one of two guide legs, three guide legs, four guide legs, and more than four guide legs.

A24. The countersink guide assembly of any of paragraphs A1-A23, wherein the guide body defines a plurality of leg receivers extending through the guide body, and wherein each guide leg of the plurality of guide legs extends through a respective leg receiver of the plurality of leg receivers to operatively couple the guide leg to the guide body.

A25. The countersink guide assembly of any of paragraphs A1-A24, wherein the guide body includes a guide base configured to face the workpiece during operative use of the countersink guide assembly, and wherein each guide leg of the plurality of guide legs extends from the guide base by a respective leg offset, as measured along a direction parallel to the guide axis.

A26. The countersink guide assembly of paragraph A25, wherein each guide leg of the plurality of guide legs has the same leg offset.

A27. The countersink guide assembly of paragraph A25, wherein the respective leg offset of one or more guide legs of the plurality of guide legs is different than the respective leg offset of one or more other guide legs of the plurality of guide legs.

A28. The countersink guide assembly of any of paragraphs A25-A27, wherein the stabilization guide includes one or more leg adjustment mechanisms, each leg adjustment mechanism configured to adjust the leg offset of a respective guide leg of the plurality of guide legs.

A29. The countersink guide assembly of paragraph A28, wherein the leg adjustment mechanism includes one or more of a threaded adjustment mechanism, a ratcheting adjustment mechanism, and a cam-lock adjustment mechanism.

A30. The countersink guide assembly of any of paragraphs A28-A29, wherein the respective guide leg includes at least a portion of the leg adjustment mechanism.

A31. The countersink guide assembly of any of paragraphs A1-A30, wherein one or more guide legs of the plurality of guide legs includes a respective guide foot configured to contact the workpiece.

A32. The countersink guide assembly of paragraph A31, wherein the guide foot is configured to remain in static contact with the workpiece as the cutter bores the countersink into the workpiece.

A33. The countersink guide assembly of any of paragraphs A31-A32, wherein each guide foot is formed of a material such that a coefficient of static friction between the guide foot and the workpiece that is greater than a coefficient of static friction between a remainder of the guide leg and the workpiece.

A34. The countersink guide assembly of any of paragraphs A31-A33, wherein the plurality of guide legs defines a guide footprint, as measured between the respective guide feet of two guide legs of the plurality of guide legs that are maximally spaced apart and as measured along a direction perpendicular to the guide axis when each guide leg of the plurality of guide legs contacts the workpiece, and wherein the guide footprint is one or more of at least 125% of a/the guide bore inner diameter, at least 175% of the guide bore inner diameter, at least 200% of the guide bore inner diameter, at least 300% of the guide bore inner diameter, at most 400% of the guide bore inner diameter, at most 250% of the guide bore inner diameter, and at most 150% of the guide bore inner diameter.

A35. The countersink guide assembly of any of paragraphs A1-A34, wherein the guide body includes a central body portion that defines the guide bore and a plurality of guide arms extending from the central body portion, and wherein each guide leg of the plurality of guide legs extends from a respective guide arm of the plurality of guide arms.

A36. The countersink guide assembly of paragraph A35, wherein the plurality of guide arms includes one of two guide arms, three guide arms, four guide arms, and more than four guide arms.

A37. The countersink guide assembly of any of paragraphs A35-A36, wherein each guide arm of the plurality of guide arms extends from the central body portion along a direction that is at least substantially perpendicular to the guide axis.

A38. The countersink guide assembly of any of paragraphs A35-A37, wherein each guide arm of the plurality of guide arms defines a respective leg receiver of a/the plurality of leg receivers.

A39. The countersink guide assembly of any of paragraphs A35-A38, wherein each guide arm of the plurality of guide arms extends from the central body portion by an arm length, as measured between the guide axis and the guide leg that extends from the guide arm and along a direction perpendicular to the guide axis, and wherein the arm length is one or more of at least 60% of a/the guide bore inner diameter, at least 75% of the guide bore inner diameter, at least 100% of the guide bore inner diameter, at least 125% of the guide bore inner diameter, at least 150% of the guide bore inner diameter, at most 200% of the guide bore inner diameter, at most 130% of the guide bore inner diameter, at most 110% of the guide bore inner diameter, at most 90% of the guide bore inner diameter, and at most 70% of the guide bore inner diameter.

A40. The countersink guide assembly of any of paragraphs A1-A39, wherein the stabilization guide further includes a guide handle extending from the guide body, wherein the guide handle is configured to be gripped by a user.

A41. The countersink guide assembly of any of paragraphs A1-A40, wherein the stabilization guide further includes one or more of:

(i) a vacuum port configured to be selectively coupled to a vacuum source; and

(ii) a vacuum conduit configured to direct a vacuum at least partially through the guide body.

B1. A method of boring a countersink into a workpiece utilizing the countersink guide assembly of any of paragraphs A1-A41, the method comprising:

(i) positioning the microstop cage within the stabilization guide; wherein the positioning includes positioning such that the cage sleeve is received within the guide bore and such that the cage sleeve is free to translate with respect to the guide bore along a direction at least substantially parallel to the guide axis;

(ii) engaging the workpiece with each guide leg of the plurality of guide legs;

(iii) contacting the workpiece with the cage base;

(iv) driving the cutter to rotate about the cage axis with the rotary driver; and

(v) transitioning the microstop cage to the extended configuration to bore the countersink into the workpiece with the cutter.

B2. The method of paragraph B1, wherein the method further includes, prior to the driving the cutter, operatively coupling the rotary driver to the cutter shaft.

B3. The method of any of paragraphs B1-B2, wherein the method further includes, prior to the transitioning the microstop cage to the extended configuration, adjusting a/the leg offset of one or more guide legs of the plurality of guide legs with a/the leg adjustment mechanism.

B4. The method of paragraph B3, wherein the adjusting is performed prior to the engaging the workpiece with the plurality of guide legs.

B5. The method of any of paragraphs B3-B4, wherein the adjusting is performed subsequent to the engaging the workpiece with the plurality of guide legs.

B6. The method of any of paragraphs B3-B5, wherein the adjusting includes adjusting such that the guide axis is at least substantially perpendicular to the workpiece.

B7. The method of any of paragraphs B3-B6, wherein the adjusting includes adjusting the leg offset of one guide leg of the plurality of guide legs.

B8. The method of any of paragraphs B3-B6, wherein the adjusting includes adjusting the leg offset of each of two or more guide legs of the plurality of guide legs.

B9. The method of any of paragraphs B1-B8, wherein the method further includes, prior to the transitioning the microstop cage to the extended configuration, adjusting a/the depth adjustment mechanism to set the countersink depth.

B10. The method of paragraph B9, wherein the adjusting the depth adjustment mechanism is performed prior to the positioning the microstop cage within the stabilization guide.

B11. The method of any of paragraphs B9-1310, wherein the adjusting the depth adjustment mechanism is performed subsequent to the positioning the microstop cage within the stabilization guide.

B12. The method of any of paragraphs B9-B11, wherein the adjusting the depth adjustment mechanism includes boring a test countersink on a test workpiece with the microstop cage to confirm the countersink depth.

B13. The method of paragraph B12, wherein the test workpiece is at least substantially planar, and wherein the workpiece is at least partially curved.

As used herein, the terms “selective” and “selectively,” when modifying an action, movement, configuration, or other activity of one or more components or characteristics of an apparatus, mean that the specific action, movement, configuration, or other activity is a direct or indirect result of user manipulation of an aspect of, or one or more components of, the apparatus.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

The various disclosed elements of apparatuses and systems and steps of methods disclosed herein are not required to all apparatuses, systems, and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus, system, or method. Accordingly, such inventive subject matter is not required to be associated with the specific apparatuses, systems, and methods that are expressly disclosed herein and such inventive subject matter may find utility in apparatuses, systems, and/or methods that are not expressly disclosed herein.

1. A countersink guide assembly, comprising:
a microstop cage; and
a stabilization guide;
wherein the microstop cage includes:
a cage sleeve;
a cutter shaft that extends within the cage sleeve; and
a cutter that is supported on the cutter shaft and that is configured to bore a countersink into a workpiece;
wherein the cutter shaft extends along a cage axis; wherein the cutter shaft is configured to be operatively coupled to a rotary driver to rotate the cutter about the cage axis to bore the countersink; wherein the cage sleeve includes a cage base; wherein at least a portion of the cage base is configured to contact the workpiece as the cutter bores the countersink into the workpiece; wherein the microstop cage is configured to be selectively transitioned between a retracted configuration, in which the cutter is at least substantially received within the cage sleeve, and an extended configuration, in which a cutter tip of the cutter extends from the cage sleeve such that a distance between the cage base and the cutter tip, as measured along a direction parallel to the cage axis, is equal to a predetermined countersink depth; wherein the cutter translates with respect to the cage sleeve in a first direction when the microstop cage transitions from the retracted configuration to the extended configuration; wherein the cutter translates with respect to the cage sleeve in a second direction that is opposite the first direction when the microstop cage transitions from the extended configuration to the retracted configuration;
wherein the stabilization guide includes:
a guide body that defines a guide bore that extends along a guide axis; and
a plurality of guide legs extending from the guide body;
wherein the guide body is a monolithic guide body; wherein the cage sleeve is received within the guide bore; wherein the cage sleeve is free to translate with respect to the guide bore along a direction at least substantially parallel to the guide axis; wherein the guide bore is configured to maintain the cage axis in an orientation that is at least substantially parallel to the guide axis; and wherein each guide leg of the plurality of guide legs is configured to contact the workpiece to stabilize the microstop cage relative to the workpiece as the cutter bores the countersink into the workpiece.

2. The countersink guide assembly of claim 1, wherein the stabilization guide is configured to maintain the cage axis in an orientation that is at least substantially perpendicular to the workpiece as the cutter bores the countersink into the workpiece.

3. The countersink guide assembly of claim 1, wherein the workpiece has a surface that is one or more of non-planar, uneven, curved, and contoured.

4. The countersink guide assembly of claim 1, further comprising the rotary driver operatively coupled to the cutter shaft.

5. The countersink guide assembly of claim 1, wherein the microstop cage includes a depth adjustment mechanism for adjusting the countersink depth.

6. (canceled)

7. The countersink guide assembly of claim 1, wherein the cage base extends fully around the cage axis.

8. The countersink guide assembly of claim 1, wherein the plurality of guide legs includes three guide legs.

9. The countersink guide assembly of claim 1, wherein the plurality of guide legs includes four guide legs.

10. The countersink guide assembly of claim 1, wherein the guide body includes a guide base configured to face the workpiece; wherein each guide leg of the plurality of guide legs extends from the guide base by a respective leg offset, as measured along a direction parallel to the guide axis; and wherein each guide leg of the plurality of guide legs has the same leg offset.

11. The countersink guide assembly of claim 1, wherein the guide body includes a guide base configured to face the workpiece; wherein each guide leg of the plurality of guide legs extends from the guide base by a respective leg offset, as measured along a direction parallel to the guide axis; and wherein the respective leg offset of one or more guide legs of the plurality of guide legs is different than the respective leg offset of one or more other guide legs of the plurality of guide legs.

12. The countersink guide assembly of claim 1, wherein the guide body includes a guide base configured to face the workpiece; wherein each guide leg of the plurality of guide legs extends from the guide base by a respective leg offset, as measured along a direction parallel to the guide axis; and wherein the stabilization guide includes one or more leg adjustment mechanisms, each leg adjustment mechanism configured to adjust the leg offset of a respective guide leg of the plurality of guide legs.

13. The countersink guide assembly of claim 1, wherein one or more guide legs of the plurality of guide legs includes a respective guide foot configured to contact the workpiece, wherein the plurality of guide legs defines a guide footprint, as measured between the respective guide feet of two guide legs of the plurality of guide legs that are maximally spaced apart and as measured along a direction perpendicular to the guide axis when each guide leg contacts the workpiece, and wherein the guide footprint is at least 175% of a guide bore inner diameter of the guide bore.

14. The countersink guide assembly of claim 1, wherein the guide body includes a central body portion that defines the guide bore and a plurality of guide arms extending from the central body portion, and wherein each guide leg of the plurality of guide legs extends from a respective guide arm of the plurality of guide arms.

15. A method of boring a countersink into a workpiece utilizing the countersink guide assembly of claim 1, the method comprising:
(i) positioning the microstop cage within the stabilization guide; wherein the positioning includes positioning such that the cage sleeve is received within the guide bore and such that the cage sleeve is free to translate with respect to the guide bore along a direction at least substantially parallel to the guide axis;
(ii) engaging the workpiece with each guide leg of the plurality of guide legs;
(iii) contacting the workpiece with the cage base;
(iv) driving the cutter to rotate about the cage axis with the rotary driver; and
(v) transitioning the microstop cage to the extended configuration to bore the countersink into the workpiece with the cutter.

16-19. (canceled)

20. A countersink guide assembly, comprising:
a microstop cage; and
a stabilization guide;
wherein the microstop cage includes:
a cage sleeve;
a cutter shaft that extends within the cage sleeve; and
a cutter that is supported on the cutter shaft and that is configured to bore a countersink into a curved surface of a workpiece;
wherein the cutter shaft extends along a cage axis; wherein the cutter shaft is configured to be operatively coupled to a rotary driver to rotate the cutter about the cage axis to bore the countersink; wherein the cage sleeve includes a cage base; wherein at least a portion of the cage base is configured to contact the workpiece as the cutter bores the countersink into the workpiece; wherein the microstop cage is configured to be selectively transitioned between a retracted configuration, in which the cutter is at least substantially received within the cage sleeve, and an extended configuration, in which a cutter tip of the cutter extends from the cage sleeve such that a distance between the cage base and the cutter tip, as measured along a direction parallel to the cage axis, is equal to a predetermined countersink depth; wherein the cutter translates with respect to the cage sleeve in a first direction when the microstop cage transitions from the retracted configuration to the extended configuration; wherein the cutter translates with respect to the cage sleeve in a second direction that is opposite the first direction when the microstop cage transitions from the extended configuration to the retracted configuration; wherein the microstop cage includes a depth adjustment mechanism for adjusting the countersink depth;
wherein the stabilization guide includes:
a guide body that defines a guide bore that extends along a guide axis; and
a plurality of guide legs extending from the guide body;
wherein the guide body is a monolithic guide body; wherein the cage sleeve is received within the guide bore; wherein the cage sleeve is free to translate with respect to the guide bore along a direction at least substantially parallel to the guide axis; wherein the guide bore is configured to maintain the cage axis in an orientation that is at least substantially parallel to the guide axis; and wherein each guide leg of the plurality of guide legs is configured to contact the workpiece to stabilize the microstop cage relative to the workpiece as the cutter bores the countersink into the workpiece; wherein the stabilization guide is configured to maintain the cage axis in an orientation that is at least substantially perpendicular to the workpiece as the cutter bores the countersink into the workpiece; wherein the guide body includes a guide base configured to face the workpiece, and wherein each guide leg of the plurality of guide legs extends from the guide base by a respective leg offset, as measured along a direction parallel to the guide axis; and wherein the stabilization guide includes one or more leg adjustment mechanisms, each leg adjustment mechanism configured to adjust the leg offset of a respective guide leg of the plurality of guide legs.

21. The countersink guide assembly of claim 1, wherein the cage sleeve has a cage sleeve outer diameter, as measured along a direction perpendicular to the cage axis; wherein the guide bore has a guide bore inner diameter, as measured along a direction perpendicular to the guide axis; and wherein the guide bore inner diameter is at most 3% larger than the cage sleeve outer diameter.

22. The countersink guide assembly of claim 1, wherein the cage sleeve has a cage sleeve outer diameter, as measured along a direction perpendicular to the cage axis; wherein the guide bore has a guide bore inner diameter, as measured along a direction perpendicular to the guide axis; and wherein the guide bore inner diameter is at most 0.7 mm larger than the cage sleeve outer diameter.

23. The countersink guide assembly of claim 1, wherein the stabilization guide further includes a guide handle extending from the guide body, wherein the guide handle is configured to be gripped by a user.

24. The countersink guide assembly of claim 1, wherein the stabilization guide further includes one or more of:
(i) a vacuum port configured to be selectively coupled to a vacuum source; and
(ii) a vacuum conduit configured to direct a vacuum at least partially through the guide body.

25. The countersink guide assembly of claim 1, wherein one or more guide legs of the plurality of guide legs includes a respective guide foot configured to contact the workpiece, and wherein each respective guide foot includes a curved surface that is configured to contact the workpiece.
